(19) United States
(12) Patent Application Publication
(10) Pub. No.: US 2024/0379276 A1
(43) Pub. Date: Nov. 14, 2024

(54) REACTOR, CONVERTER AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masaya MURASHITA, Mie (JP); Kazuhiro INABA, Mie (JP); Naotoshi FURUKAWA, Mie (JP)

(21) Appl. No.: 18/691,259

(22) PCT Filed: Sep. 16, 2022
(86) PCT No.: PCT/JP2022/034852

§ 371 Date: Mar. 12, 2024

(30) Foreign Application Priority Data
Sep. 24, 2021 (JP) 2021-156094

(51) Int. Cl. H01F 27/255; H01F 27/32; H01F 37/00

(52) U.S. Cl. CPC H01F 27/255; H01F 27/32; H01F 37/00

(57) ABSTRACT

A reactor is provided with a coil including a winding portion, a magnetic core including an E-shaped first core portion, a T- or E-shaped second core portion and a gap portion, and a molded resin portion. The first core portion is a compact of a composite material including a first middle core portion. The second core portion is a powder compact including a second middle core portion. The gap portion is arranged between an end surface of the first middle core portion and an end surface of the second middle core portion inside the winding portion. The end surface of the first middle core portion has an annular outer end surface, a peripheral surface and an inner end surface. The end surface of the second middle core portion, the outer end surface and the inner end surface are flat surfaces.

### TECHNICAL FIELD

The present disclosure relates to a reactor, a converter and a power conversion device.

This application claims a priority based on Japanese Patent Application No. 2021-156094 filed on Sep. 24, 2021, all the contents of which are hereby incorporated by reference.

### BACKGROUND

A reactor of Patent Document 1 is provided with a coil, a magnetic core and a molded resin portion. The coil includes a winding portion. The winding portion is formed by spirally winding a wiring wire. The magnetic core includes an inner core portion and an outer core portion. The inner core portion is arranged inside the winding portion. The inner core portion includes a plurality of inner core pieces and a gap portion provided between the adjacent inner core pieces. The outer core portion is arranged outside the winding portion. The molded resin portion covers at least a part of an assembly of the coil and the magnetic core. The molded resin portion includes a part filled in the gap portion.

### PRIOR ART DOCUMENT

### Patent Document

Patent Document 1: JP 2017-139310 A

### SUMMARY OF THE INVENTION

The present disclosure is directed to a reactor with a coil including a tubular winding portion, a magnetic core including a first core portion and a second core portion combined in an axial direction of the winding portion and a gap portion provided between the first and second core portions, and a molded resin portion covering at least a part of the magnetic core, one winding portion being provided, the first core portion being E-shaped, the second core portion being T-shaped or E-shaped, the first core portion being a compact of a composite material including a first middle core portion arranged inside the winding portion, the second core portion being a powder compact including a second middle core portion arranged inside the winding portion, the gap portion being arranged between an end surface of the first middle core portion and an end surface of the second middle core portion inside the winding portion, the end surface of the first middle core portion having an annular outer end surface connected to an outer peripheral surface of the first middle core portion, a peripheral surface extending from the outer end surface toward the end surface of the second middle core portion and an inner end surface connected to a tip of the peripheral surface, the end surface of the second middle core portion being a flat surface, the outer end surface and the inner end surface being flat surfaces, a ratio of an area of the inner end surface to an area of the outer end surface being 0.30 or more and 1.35 or less, and the molded resin portion including a part to be provided between the outer end surface and the end surface of the second middle core portion.

### BRIEF DESCRIPTION OF THE DRAWINGS

FIG. 1 is a schematic perspective view showing an entire reactor according to a first embodiment.

FIG. 2 is a schematic side view showing the entire reactor of the first embodiment.

FIG. 3 is a schematic perspective view showing the reactor of the first embodiment in a disassembled state.

FIG. 4 is a schematic plan view of an end surface of a first core portion provided in the reactor of the first embodiment when viewed from a first direction.

FIG. 5 is a schematic top view showing the entire reactor of the first embodiment.

FIG. 6 is a schematic enlarged view enlargedly showing a region A of FIG. 5.

FIG. 7 is a schematic top view showing an entire reactor of a second embodiment.

FIG. 8 is a configuration diagram schematically showing a power supply system of a hybrid vehicle.

FIG. 9 is a circuit diagram showing an example of a power conversion device provided with a converter.

### TECHNICAL PROBLEM

In the reactor of Patent Document 1, the end surface of each inner core piece is a flat surface. That is, the gap portion is provided between two end surfaces, which are flat surfaces. If an interval between the two end surfaces is narrow, it is difficult to fill the molded resin portion between the two end surfaces. If the amount of the molded resin portion filled between the two end surfaces is small, it is difficult to keep the interval. If the interval is widened to increase the amount of the molded resin portion filled between the two end surfaces, a desired inductance may not be obtained.

One object of the present disclosure is to provide a reactor having high fillability of a molded resin portion into a gap portion in a magnetic core and having a high inductance. Another object of the present disclosure is to provide a converter provided with the above reactor. Still another object of the present disclosure is to provide a power conversion device provided with the above converter.

### Effect of Present Disclosure

The reactor of the present disclosure has high fillability of a molded resin portion into a gap portion in a magnetic core and has a high inductance.

### Description of Embodiments of Present Disclosure

First, embodiments of the present disclosure are listed and described.

(1) A reactor according to one aspect of the present disclosure is provided with a coil including a tubular winding portion, a magnetic core including a first core portion and a second core portion combined in an axial direction of the winding portion and a gap portion provided between the first and second core portions, and a molded resin portion covering at least a part of the magnetic core, one winding portion being provided, the first core portion being E-shaped, the second core portion being T-shaped or E-shaped, the first core portion being a compact of a composite material including a first middle core portion arranged inside the winding portion, the second core portion being a powder compact including a second middle core portion arranged inside the winding portion, the gap portion being arranged between an end surface of the first middle core portion and an end surface of the second middle core portion inside the winding portion, the end surface of the first middle core portion having an annular outer end surface connected to an outer peripheral surface of the first middle core portion, a peripheral surface extending from the outer end surface toward the end surface of the second middle core portion and an inner end surface connected to a tip of the peripheral surface, the end surface of the second middle core portion being a flat surface, the outer end surface and the inner end surface being flat surfaces, a ratio of an area of the inner end surface to an area of the outer end surface being 0.30 or more and 1.35 or less, and the molded resin portion including a part to be provided between the outer end surface and the end surface of the second middle core portion.

Out of the gap portion, a gap portion provided between the outer end surface and the end surface of the second middle core portion may be referred to as an outer gap portion and a gap portion provided between the inner end surface and the end surface of the second middle core portion may be referred to as an inner gap portion below.

The above reactor has high fillability of the molded resin portion into the gap portion. The reason for that is as follows. A part of a constituent material of the molded resin portion is filled into the inside of the winding portion in a molding process of the molded resin portion. The outer end surface, the inner end surface and the end surface of the second middle core portion are flat surfaces. Thus, a thickness of the outer gap portion is larger than that of the inner gap portion. The outer end surface is annularly provided. Thus, the outer gap portion is annularly provided. Since the ratio of the area of the inner end surface to the area of the outer end surface is 1.35 or less, a ratio of the outer gap portion is properly ensured. Thus, the constituent material of the molded resin portion filled into the inside of the winding portion easily spreads between the end surfaces of the first and second middle core portions.

The above reactor has a high inductance. The reason for that is as follows. A length between the inner end surface and the end surface of the second middle core portion is shorter than a length between the outer end surface and the end surface of the second middle core portion. Since the ratio of the area of the inner end surface to the area of the outer end surface is 0.30 or more, a ratio of the inner gap portion is properly ensured.

The above reactor is excellent in heat dissipation. This is because heat conduction between the first and second core portions tends to increase since the molded resin portion includes the part to be provided between the outer end surface and the end surface of the second middle core portion.

The above reactor has a low loss. This is because a leakage magnetic flux hardly enters the winding portion since the gap portion is arranged inside the winding portion and, thus, an eddy current loss occurring in the winding portion is easily reduced.

(2) In the reactor of (1) described above, a ratio of a length between the outer end surface and the end surface of the second middle core portion to a length between the inner end surface and the end surface of the second middle core portion may be 3.00 or more and 15.00 or less.

The reactor of the above aspect having the ratio of 3.00 or more has high fillability of the molded resin portion into the gap portion. This is because the constituent material of the molded resin portion filled into the inside of the winding portion easily spreads between the end surfaces of the first and second core portions. The reactor of the above aspect having the ratio of 15.00 or less has a high inductance. This is because a thickness of the outer gap portion is not excessively large. Further, the reactor of the above aspect has a low loss.

(3) In the reactor of (1) or (2) described above, a length of the second middle core portion along the axial direction of the winding portion may be shorter than a length of the first middle core portion along the axial direction of the winding portion, and a length from an end surface of the winding portion facing the second core portion to the gap portion may be 0.2 times or more and 0.49 times or less of a length of the winding portion.

The reactor of the above aspect has a low loss for the following reasons. A ratio of the powder compact having a larger loss than the compact of the composite material tends to be reduced since the length of the second middle core portion is shorter than that of the first middle core portion. Further, in the reactor of the above aspect, a leakage magnetic flux hardly enters the winding portion since the gap portion is arranged inside the winding portion and the length from the end surface of the winding portion to the gap portion is 0.2 times or more of the length of the winding portion. Thus, an eddy current loss occurring in the winding portion is easily reduced. Further, a ratio of the compact of the composite material having a lower loss than the powder compact can be increased inside the winding portion since the length from the end surface to the gap portion is 0.49 times or less of the length of the winding portion.

The reactor of the above aspect can suppress problems such as an influence on peripheral devices due to the leakage magnetic flux. This is because the leakage of a magnetic flux to the outside of the winding portion is easily suppressed since the gap portion is arranged inside the winding portion and the length from the end surface to the gap portion is 0.2 times or more of the length of the winding portion in the reactor of the above aspect.

The reactor of the above aspect has high fillability of the molded resin portion into the gap portion. This is because the constituent material of the molded resin portion easily spreads between the outer end surface and the end surface of the second middle core portion since the length from the end surface to the gap portion is 0.49 times or less of the length of the winding portion.

(4) In the reactor of any one of (1) to (3) described above, a ratio of a thickness of the gap portion to a total length of a length of the first middle core portion along the axial direction of the winding portion, a length of the second middle core portion along the axial direction of the winding portion and the thickness of the gap portion may be 0.02 or more and 0.05 or less.

The thickness of the gap portion mentioned here is a length between the outer end surface and the end surface of the second middle core portion along the axial direction of the winding portion. That is, the thickness of the gap portion is a thickness of the outer gap portion.

The reactor of the above aspect has high fillability of the molded resin portion into the gap portion since the above ratio is 0.02 or more. The reactor of the above aspect has a high inductance since the above ratio is 0.05 or less. Moreover, the reactor of the above aspect has a small leakage magnetic flux and an effect of reducing an eddy current loss tends to be high.

(5) In the reactor of any one of (1) to (4) described above, the thickness of the gap portion may be 1.0 mm or more and 2 mm or less.

The reactor of the above aspect has high fillability of the molded resin portion into the gap portion since the above thickness is 1.0 mm or more. The reactor of the above aspect has a high inductance since the above thickness is 2 mm or less. Moreover, the reactor of the above aspect has a small leakage magnetic flux and the effect of reducing an eddy current loss tends to be high.

(6) In the reactor of any one of (1) to (5) described above, the powder compact may be a compact of a raw material powder containing a soft magnetic powder, and a content of the soft magnetic powder in the powder compact may be 85% by volume or more and 99% by volume or less.

The above powder compact easily enhances magnetic properties as compared to the compact of the composite material.

(7) In the reactor of any one of (1) to (6) described above, the compact of the composite material may be a compact in which a soft magnetic powder is dispersed in a resin, and a content of the soft magnetic powder in the compact of the composite material may be 20% by volume or more and 80% by volume or less.

The above compact of the composite material easily adjusts magnetic properties and is easily formed even if having a complicated shape as compared to the powder compact.

(8) A converter according to one aspect of the present disclosure is provided with the reactor of any one of (1) to (7) described above.

The above converter is excellent in performance since including the above reactor.

(9) A power conversion device according to one aspect of the present disclosure is provided with the converter of (8) described above.

The above power conversion device is excellent in performance since including the above converter.

### Details of Embodiments of Present Disclosure

Embodiments of the present disclosure are described in detail below with reference to the drawings. The same reference signs in figures denote the same components.

### First Embodiment

### [Reactor]

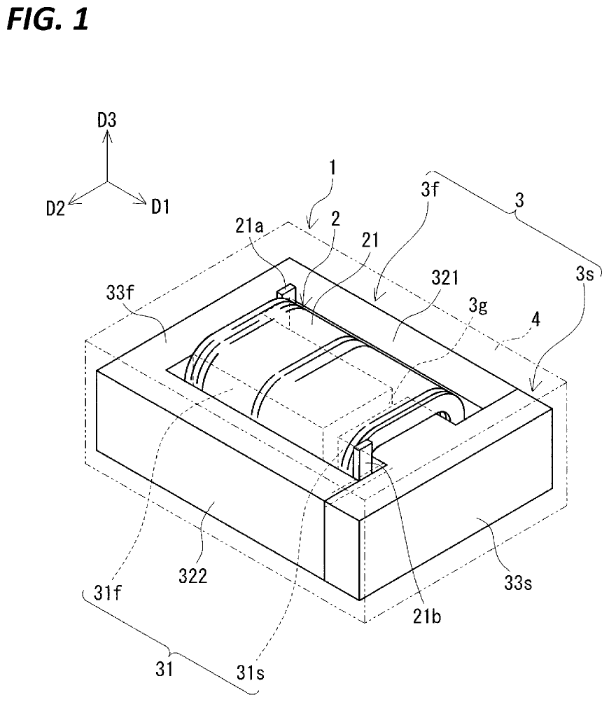

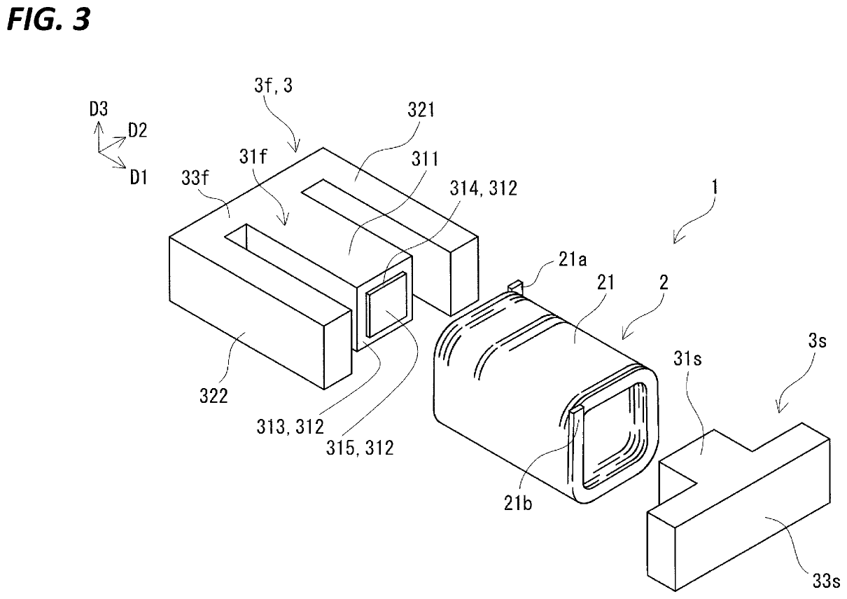

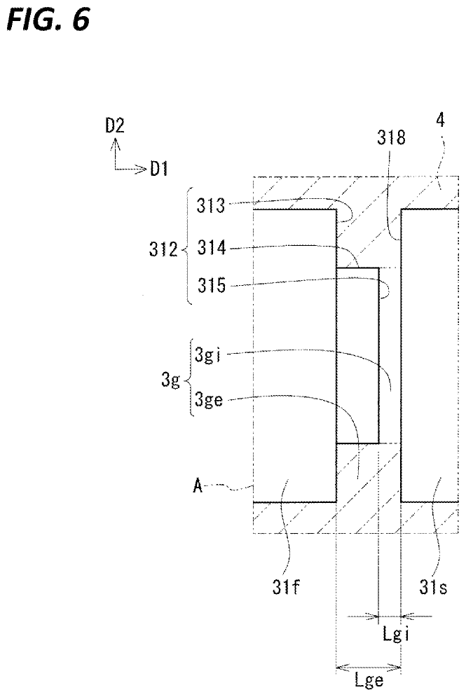

A reactor 1 of a first embodiment is described with reference to FIGS. 1 to 6. As shown in FIG. 1, the reactor 1 is provided with a coil 2, a magnetic core 3 and a molded resin portion 4. The coil 2 includes a tubular winding portion 21. One winding portion 21 is provided. The magnetic core 3 includes a first core portion 3f, a second core portion 3s and a gap portion 3g. The first and second core portions 3f, 3s are combined in an axial direction of the winding portion 21. The gap portion 3g is provided between the first and second core portions 3f, 3s. The molded resin portion 4 covers at least a part of the magnetic core 3. One of features of the reactor 1 of this embodiment is to satisfy the following requirements (a) to (e).
(a) The first and second core portions 3f, 3s have specific shapes.
(b) The first and second core portions 3f, 3s are constituted by specific compacts.
(c) The gap portion 3g is located at a specific position.
(d) An end surface 312 of a first middle core portion 31f provided in the first core portion 3f as shown in FIG. 3 and an end surface 318 of a second middle core portion 31s provided in the second core portion 3s as shown in FIG. 6 have specific shapes.
(e) As shown in FIG. 6, the molded resin portion 4 includes a part provided in a specific region of the gap portion 3g.

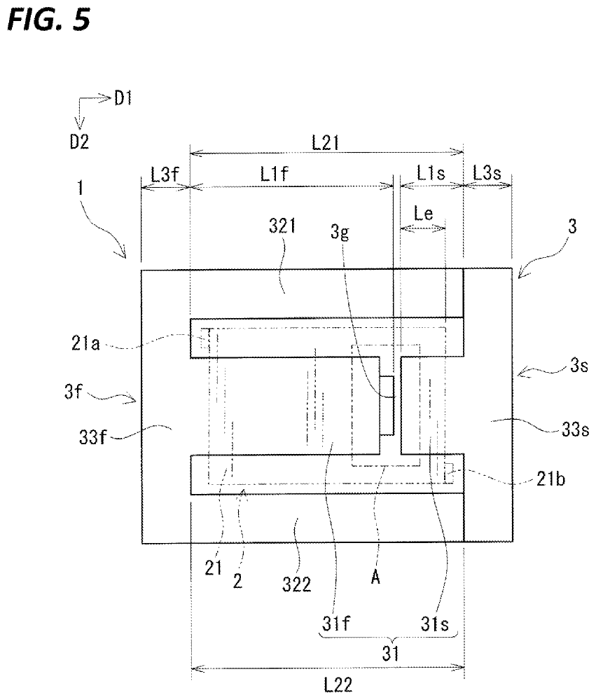

FIG. 5 shows the coil 2 by a two-dot chain line for the convenience of description. In the following description, a first direction D1, a second direction D2 and a third direction D3 defined as below may be used.

The first direction D1 is a direction along the axial direction of the winding portion 21.

The second direction D2 is a direction along a parallel direction of the first middle core portion 31f, a first side core portion 321 and a second side core portion 322 to be described later.

The third direction D3 is a direction orthogonal to both the first and second directions D1, D2.

### [Coil]

As shown in FIGS. 1 and 3, the winding portion 21 of the coil 2 is formed by spirally winding one winding wire having no joint. Since one winding portion 21 is provided, a length along the second direction D2 can be shortened as compared to the case where a plurality of winding portions are arranged in parallel in the second direction D2.

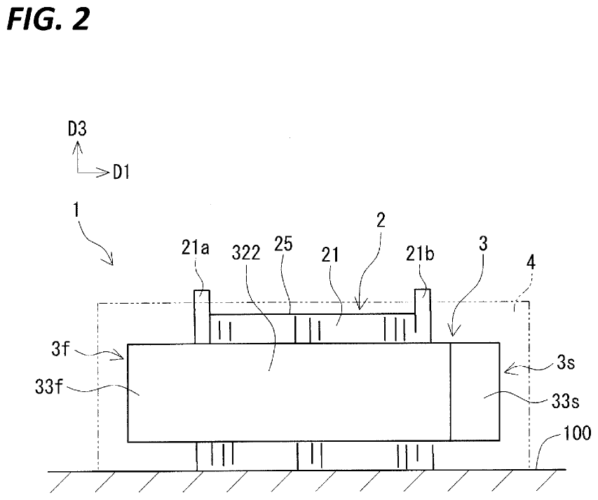

The winding portion 21 of this embodiment has a rectangular tube shape. Rectangular shapes include quadrilateral shapes with longer and short sides and square shapes. The end surface shape of the winding portion 21 of this embodiment is a rectangular frame shape. Since the winding portion 21 has a rectangular tube shape, a contact area of the winding portion 21 and an installation target 100 is easily increased as compared to the case where the winding portion 21 has a circular tube shape having the same cross-sectional area. Thus, the reactor 1 easily dissipates heat to the installation target 100 shown in FIG. 2 via the winding portion 21. Moreover, the winding portion 21 is easily disposed on the installation target 100. The installation target 100 is, for example, a cooling base or the inner bottom surface of a case to be described later. Corner parts of the winding portion 21 are rounded. Unlike this embodiment, the winding portion 21 has a circular tube shape. Circular shapes include true circular shapes and elliptical shapes.

A known winding wire can be used as the winding wire. A coated rectangular wire is used as the winding wire of this embodiment. A conductor wire of the coated rectangular wire is constituted by a rectangular wire made of copper. An insulation coating of the coated rectangular wire is made of enamel. The winding portion 21 is constituted by an edgewise coil formed by winding the coated rectangular wire in an edgewise manner.

A first end part 21a and a second end part 21b of the winding portion 21 are respectively pulled out to an outer peripheral side of the winding portion 21 on first and second end parts in the axial direction of the winding portion 21 in this embodiment. Although not shown, the insulation coating is stripped to expose the conductor wire in the first and second end parts 21a, 21b. The exposed parts of the conductor wire are pulled out to the outside of the molded resin portion 4 as shown in FIG. 2. Terminal members are connected to the exposed parts of the conductor wire. The terminal members are not shown. An external device is connected to the coil 2 via these terminal members. The external device is not shown. The external device is a power supply for supplying power to the coil 2 or the like.

An outer peripheral surface 25 of the winding portion 21 has a part to be held in contact with the installation target 100 of the reactor 1. Thus, the reactor 1 easily enhances heat dissipation. The outer peripheral surface 25 has a part projecting further in the third direction D3 than the magnetic core 3. That is, a length along the third direction D3 of the winding portion 21 is longer than that of the magnetic core 3. Since the winding portion 21 has a rectangular tube shape in this embodiment, the outer peripheral surface 25 of the winding portion 21 has four flat surfaces. In this embodiment, one of the four flat surfaces is the part to be held in contact with the installation target 100. Thus, the winding portion 21 can secure a sufficient contact area with the installation target 100. Therefore, the reactor 1 more easily enhances heat dissipation. In this embodiment, the above contact part of the winding portion 21 is exposed from the molded resin portion 4 to be described later. Thus, heat of the coil 2 is easily dissipated via the installation target 100.

### [Magnetic Core]

As shown in FIG. 1, the magnetic core 3 is an assembly obtained by combining the first and second core portions 3f, 3s in the first direction D1. Since the magnetic core 3 can be constructed by combining the first and second core portions 3f, 3s in the first direction D1, the reactor 1 is excellent in manufacturing workability. The gap portion 3g to be described later is provided between the first and second core portions 3f, 3s. A combination of the first and second core portions 3f, 3s is an E-T type in this embodiment. Unlike this embodiment, the combination may be an E-E type. These combinations more easily adjust an inductance and heat dissipation. The first core portion 3f is constituted by a compact of a composite material to be described later. The second core portion 3s is a constituted by a powder compact to be described later.

A total volume Va of a volume of the first core portion 3f, that of the second core portion 3s and that of the gap portion 3g is 50 cm³ or more and 500 cm³ or less. The reactor 1 having the total volume of 50 cm³ or more and 500 cm³ or less is suitable for a converter of an electric vehicle, a hybrid vehicle or a fuel cell vehicle. Since the winding portion 21 has the part to be held in contact with the installation target 100 and the second core portion 3s is constituted by a powder compact, heat of the magnetic core 3 is easily dissipated even if the total volume Va is 50 cm³ or more. Since the total volume Va is 500 cm³ or less, the reactor 1 is hardly excessively enlarged. The total volume Va is further preferably 60 cm³ or more and 400 cm³ or less, particularly preferably 70 cm³ or more and 300 cm³ or less. The volume of the gap portion 3g is a volume of a space surrounded by the end surface 312 of the first middle core portion 31f, the end surface 318 of the second middle core portion 31s and a virtual outer peripheral surface. The virtual outer peripheral surface is an outer peripheral surface, which would be obtained by extending an outer peripheral surface 311 of the first middle core portion 31f in the first direction D1.

### (First Core Portion)

As shown in FIG. 5, the first core portion 3f has an E-shaped planar shape. The planar shape of the first core portion 3f means the shape of the first core portion 3f when viewed from the third direction D3. A concept of the planar shape similarly applies to the second core portion 3s to be described later. The first core portion 3f includes a first end core portion 33f, the first middle core portion 31f, the first side core portion 321 and the second side core portion 322. The first end core portion 33f and the first end surface of the winding portion 21 are facing each other. The first middle core portion 31f includes a part arranged inside the winding portion 21. The first and second side core portions 321, 322 are arranged to face each other across the first middle core portion 31f. The first and second side core portions 321, 322 are arranged on the outer periphery of the winding portion 21.

As shown in FIG. 3, the first core portion 3f is a compact in which the first end core portion 33f, the first middle core portion 31f, the first side core portion 321 and the second side core portion 322 are integrated. The first end core portion 33f connects the first middle core portion 31f, the first core portion 321 and the second side core portion 322. The first and second side core portions 321, 322 are provided on both ends of the first end core portion 33f. The first middle core portion 31f is provided in a center of the first end core portion 33f.

The first end core portion 33f has a thin angular column shape in this embodiment. The first and second side core portions 321, 322 have the same shape. In this embodiment, the first and second side core portions 321, 322 have a thin angular column shape.

The first middle core portion 31f has a shape corresponding to the inner peripheral shape of the winding portion 21. The first middle core portion 31f of this embodiment has a rectangular column shape.

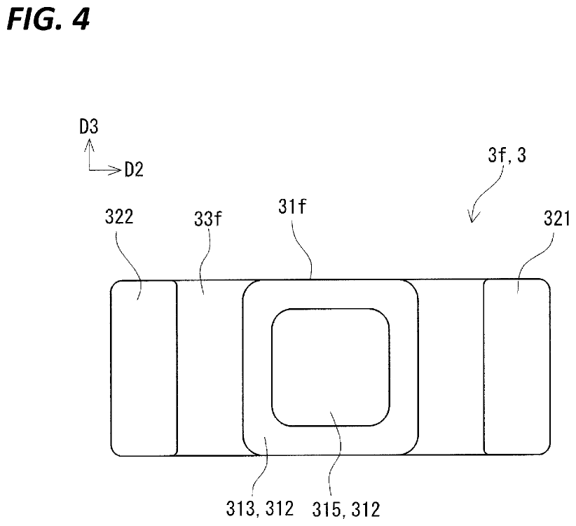

As shown in FIG. 3, the first middle core portion 31f has the outer peripheral surface 311 and the end surface 312. The outer peripheral surface 311 is a surface facing the inner peripheral surface of the winding portion 21. Although corner parts of the outer peripheral surface 311 are shown to be angular in FIG. 3, these corner parts are rounded along the inner peripheral surfaces of corner parts of the winding portion 21 as shown in FIG. 4.

As shown in FIGS. 3 and 6, the end surface 312 has an outer end surface 313, a peripheral surface 314 and an inner end surface 315. The outer end surface 313 is connected to the peripheral surface 313. The outer end surface 313 is an annular flat surface. The peripheral surface 314 of this embodiment is a rectangular annular flat surface as shown in FIG. 4. The peripheral surface 314 is connected to the outer end surface 313 and the inner end surface 315 as shown in FIGS. 3 and 6. The peripheral surface 314 is a tubular surface extending from the outer end surface 313 toward the end surface 318. The peripheral surface 314 of this embodiment is a surface having a rectangular tube shape. The peripheral surface 314 may be a tubular surface linearly extending along the first direction D1 or may be a tubular shape tapered from the outer end surface 313 toward the inner end surface 315. The inner end surface 315 is a flat surface. The planar shape of the inner end surface 315 of this embodiment is, as shown in FIG. 4, similar to the contour shape of the outer peripheral surface 311. That is, the planar shape of the inner end surface 315 of this embodiment is rectangular. Unlike this embodiment, the planar shape of the inner end surface 315 may be different from the contour shape of the outer peripheral surface 311. For example, the planar shape of the inner end surface 315 may be circular. Since the outer end surface 313, the inner end surface 315 and the end surface 318 are flat surfaces, a length Lge along the first direction D1 between the outer end surface 313 and the end surface 318 is longer than a length Lgi along the first direction D1 between the inner end surface 315 and the end surface 318 as shown in FIG. 6. In other words, the length Lgi is shorter than the length Lge.

A ratio of an area S1 of the inner end surface 315 to an area Se of the outer end surface 313, i.e. area Si/area Se, is 0.30 or more and 1.35 or less (see FIG. 4). The reactor 1 having the area Si/area Se of 0.30 or more has a high inductance. Since the area Si/area Se is 0.3 or more, a ratio of an inner gap portion 3gi to be described with refence to FIG. 6 is properly ensured. The reactor 1 having the area Si/area Se of 1.35 or less has high fillability of the molded resin portion 4 into the gap portion 3g. The reason for that is as follows. A part of a constituent material of the molded resin portion 4 is filled into the inside of the winding portion 21 in a molding process of the molded resin portion 4. An outer gap portion 3ge to be described later with reference to FIG. 6 is annular. Since the area Si/area Se is 1.35 or less, a ratio of the outer gap portion 3ge is properly ensured. Thus, the constituent material of the molded resin portion 4 filled into the inside of the winding portion 21 easily spreads between the end surfaces 312 and 318. The area Si/area Se may be 0.31 or more and 1.25 or less, or may be 0.32 or more and 1.15 or less. The area Si/area Se may be 0.32 or more and 1.00 or less, or may be 0.32 or more and 0.85 or less.

An example of a length of the peripheral surface 314 shown in FIGS. 3 and 6, i.e. an example of the length between the outer end surface 313 and the inner end surface 315, is a length at which length Lge/length Lgi to be described later satisfies a range to be described later.

The sum of a cross-sectional area of the first side core portion 321 and that of the second side core portion 322 in this embodiment is equal to each of a cross-sectional area of the first middle core portion 31f and that of the second middle core portion 31s. The cross-sectional area mentioned here is a cross-sectional area along a cut surface orthogonal to the first direction D1.

As shown in FIG. 5, a length L1f along the first direction D1 of the first middle core portion 31f is shorter than a length along the first direction D1 of the winding portion 21. The length L1f is a length along the first direction D1 between a part of the first middle core portion 31f connected to the first end part 33f and the inner end surface 315. The length along the first direction D1 of the winding portion 21 is a length along the first direction D1 between the first and second end surfaces of the winding portion 21. If there are gaps between turns of the winding portion 21, the length along the first direction D1 of the winding portion 21 include lengths of the gaps between the turns. A length along the second direction D2 of the first middle core portion 31f is longer than each of a length along the second direction D2 of the first side core portion 321 and that of the second side core portion 322. As shown in FIG. 1, a length along the third direction D3 of the first middle core portion 31f is equal to each of a length along the third direction D3 of the first side core portion 321 and that of the second side core portion 322.

As shown in FIG. 5, a length L21 along the first direction D2 of the first side core portion 321 and a length L22 along the first direction D1 of the second side core portion 322 are equal. The lengths L21, L22 are longer than the length L1f and longer than the length along the first direction D1 of the winding portion 21. A length along the second direction D2 of the first side core portion 321 and that of the second side core portion 322 are equal. As shown in FIG. 1, a length along the third direction D3 of the first side core portion 321 and that of the second side core portion 322 are equal.

### (Second Core Portion)

The second core portion 3s has a T-shaped planar shape as shown in FIG. 5 in this embodiment. Unlike this embodiment, the second core portion 3s may have an E-shaped planar shape. As described above, the second core portion 3s is constituted by a powder compact. A powder compact having a T-shaped planar shape is easily manufactured as compared to a powder compact having an E-shaped planar shape. Thus, the powder compact having a T-shaped planar shape tends to be accurately manufactured as compared to the powder compact having an E-shaped planar shape. Thus, the second core portion 3s having a T-shaped planar shape hardly provides unnecessary gaps when being combined with the first core portion 3f as compared to the case where the second core portion 3s has an E-shaped planar shape.

The second core portion 3s of this embodiment includes a second end core portion 33s and the second middle core portion 31s. The second end core portion 33s and the second end surface of the winding portion 21 are facing each other. The second middle core portion 31s includes a part to be arranged inside the winding portion 21. As shown in FIG. 3, the second core portion 3s is a compact in which the second end core portion 33s and the second middle core portion 31s are integrated. The second middle core portion 31s is provided in a center of the second end core portion 33s.

The second end core portion 33s has the same shape as the first end core portion 33f. That is, the second end core portion 33s has a thin angular column shape. The second middle core portion 31s has a rectangular column shape. Corner parts of the second middle core portion 31s are rounded along the inner peripheral surfaces of the corner parts of the winding portion 21. The end surface 318 of the second middle core portion 31s is a flat surface.

As shown in FIG. 5, in this embodiment, a length L1s along the first direction D1 of the second middle core portion 31s is shorter than the length L1f. The sum of the lengths L1s, L1f is shorter than each of the lengths L21, L22. A length along the second direction D2 of the second middle core portion 31s is equal to that of the first middle core portion 31f. As shown in FIG. 1, a length along the third direction D3 of the second middle core portion 31s is equal to that of the first middle core portion 31f.

As shown in FIG. 5, a length L3s along the first direction D1 of the second end core portion 33s is equal to the length L3f along the first direction D1 of the first end core portion 33f. A length along the second direction D2 of the second end core portion 33s is equal to that of the first end core portion 33f. The length along the second direction D2 of the second end core portion 33s is longer than that of the winding portion 21. As shown in FIG. 1, a length along the third direction D3 of the second end core portion 33s is equal to that of the first end core portion 33f. As shown in FIG. 2, the length along the third direction D3 of the second end core portion 33s is shorter than that of the winding portion 21. As shown in FIG. 1, the length along the third direction D3 of the second end core portion 33s is equal to that of the second middle core portion 31s.

An example of a volume ratio Vps obtained by (volume Vs/total volume Va)×100 is 25% or more and 40% or less. As described above, the volume Vs is a total volume of the second core portion 3s. The total volume Va is a total of the volume of the first core portion 3f, that of the second core portion 3s and that of the gap portion 3g as described above. If the volume ratio Vps is 25% or more, the heat dissipation of the reactor 1 tends to increase. If the volume ratio Vps is 40% or less, a loss of the reactor 1 tends to be reduced. The volume ratio Vps may be 27% or more and 38% or less, or may be 29% or more and 36% or less.

An example of a volume ratio Vpm obtained by (volume Vms/total volume Vma)×100 is 15% or more and 49% or less. The volume Vms is a volume of the second middle core portion 31s. The total volume Vma is a total volume of the volume of the first middle core portion 31f, that of the second middle core portion 31s and that of the gap portion 3g. If the volume ratio Vpm is 15% or more, the heat dissipation of the reactor 1 tends to increase. If the volume ratio Vpm is 49% or less, a loss of the reactor 1 tends to be reduced. The volume ratio Vpm may be 20% or more and 40% or less, or may be 25% or more and 35% or less.

The first and second core portions 3f, 3s are so combined that the end surface of the first side core portion 321 and that of the second side core portion 322 are in contact with the end surface of the second end core portion 33s. An interval is provided between the end surface 312 of the first middle core portion 31f and the end surface 318 of the second middle core portion 31s. The gap portion 3g to be described later is provided between the end surfaces 312 and 318.

The compact of the composite material constituting the first core portion 3f is a compact in which a soft magnetic powder is dispersed in a resin. The compact of the composite material is obtained by filling a fluid raw material, in which the soft magnetic powder is dispersed in the uncured resin, into a mold and solidifying the resin. The compact of the composite material can easily adjusts a content of the soft magnetic powder in the resin. Thus, the compact of the composite material easily adjust magnetic properties. Moreover, the compact of the composite material is easily formed into even a complicated shape as compared to the powder compact. An example of the content of the soft magnetic powder in the compact of the composite material is, for example, 20% by volume or more and 80% by volume or less. An example of the content of the resin in the compact of the composite material is, for example, 20% by volume or more and 80% by volume or less. These contents are values when the compact of the composite material is 100% by volume.

The powder compact constituting the second core portion 3s is a compact obtained by compression-forming the soft magnetic powder. The powder compact has a higher content of the soft magnetic powder in the core portion as compared to the compact of the composite material. Thus, the powder compact easily enhances magnetic properties. A relative magnetic permeability and a saturated magnetic flux density can be cited as the magnetic properties. The powder compact is excellent in heat dissipation since containing less resin and more soft magnetic powder than the compact of the composite material. An example of a content of the magnetic powder in the powder compact is, for example, 85% by volume or more and 99.99% by volume or less. This content is a value when the powder compact is 100% by volume.

Particles constituting the soft magnetic powder include particles and coated particles of soft magnetic metal, particles of soft magnetic nonmetal and the like. The coated particle includes a particle of soft magnetic metal and an insulation coating provided on the outer periphery of the particle of soft magnetic metal. The soft magnetic metal is pure iron, an iron-based alloy or the like. The iron-based alloy is, for example, a Fe—Si alloy or a Fe—Ni alloy. The insulation coating is, for example, a phosphate. The soft magnetic nonmetal is, for example, ferrite.

The resin of the compact of the composite material is, for example, a thermosetting resin or a thermoplastic resin. The thermosetting resin is, for example, an epoxy resin, a phenol resin, a silicone resin or a urethane resin. The thermoplastic resin is, for example, a polyphenylene sulfide resin, a polyamide resin, a liquid crystal polymer, a polyimide resin or a fluororesin. The polyamide resin is, for example, nylon 6, nylon 66 or nylon 9T.

The compact of the composite material may contain a ceramic filler. The ceramic filler is, for example, alumina or silica. The ceramic filler contributes to improving heat dissipation and electrical insulation.

A content of the soft magnetic powder in the compact of the composite material and a content of the soft magnetic powder in the powder compact are assumed to be equivalent to area ratios of the soft magnetic powder in cross-sections of the compacts. The content of the soft magnetic powder in the compact is obtained as follows. A cross-section of the compact is observed by a SEM (scanning electron microscope) and observation images are obtained. The cross-section of the compact is an arbitrary cross-section. A magnification of the SEM is set to 200× or more and 500× or less. The number of the obtained observation images is 10 or more. A total cross-sectional area is 0.1 cm² or more. One observation image may be obtained for one cross-section or a plurality of observation images may be obtained for one cross-section. An image processing is applied to each obtained observation image to extract the contours of the particles. The image processing is, for example, a binarization processing. An area ratio of soft magnetic particles in each observation image is calculated and an average value of the area ratios is obtained. That average value is assumed as the content of the soft magnetic powder.

Since the first core portion 3f is constituted by the compact of the composite material and the second core portion 3s is constituted by the powder compact, an inductance is easily adjusted and heat dissipation is easily adjusted without via the long gap portion 3g. The reactor 1 easily enhances heat dissipation since the second core portion 3s is constituted by the powder compact having a relatively high thermal conductivity.

### (Gap Portion)

The gap portion 3g is arranged inside the winding portion 21. The gap portion 3g is arranged between the end surface 312 of the first middle core portion 31f and the end surface 318 of the second middle core portion 31s. Since the gap portion 3g is provided inside the winding portion 21, a leakage magnetic flux hardly enters the winding portion 21 as compared to the case where the gap portion 3g is provided outside the winding portion 21. Therefore, an eddy current loss occurring in the winding portion 21 is easily reduced.

As shown in FIG. 6, the gap portion 3g includes the outer gap portion 3ge and the inner gap portion 3gi. The outer gap portion 3ge is provided between the outer end surface 313 and the end surface 318. The inner gap portion 3gi is provided between the inner end surface 315 and the end surface 318.

The gap portion 3g is constituted by a member made of a material having a smaller relative permeability than the first and second core portions 3f, 3s. At least a part of the gap portion 3g is constituted by a part of the molded resin portion 4 to be described later. The gap portion 3g may be constituted only by the molded resin portion 4 or may be constituted by the molded resin portion 4 and an air gap. In this embodiment, as shown in FIG. 6, the outer gap portion 3ge is constituted by the molded resin portion 4, and the inner gap portion 3gi is substantially constituted by an air gap.

An example of a ratio of a thickness of the outer gap portion 3ge to that of the inner gap portion 3gi is 3.00 or more and 15.00 or less. The thickness of the inner gap portion 3gi is the length Lgi. The thickness of the outer gap portion 3ge is the length Lge. That is, the ratio of the thickness of the outer gap portion 3ge to that of the inner gap portion 3gi is length Lge/length Lgi.

The reactor 1 having the length Lge/length Lgi of 3.00 or more has high fillability of the molded resin portion 4 into the gap portion 3g. The reactor 1 having the length Lge/length Lgi of 15.00 or less has a high inductance. The reactor 1 having the length Lge/length Lgi of 3.00 or more and 15.00 or less has a low loss. The length Lge/length Lgi may be 3.25 or more and 12.5 or less, or may be 3.50 or more and 10.00 or less. The length Lge/length Lgi may be 3.50 or more and 7.00 or less.

An example of a ratio of the thickness of the gap portion 3g to a total length of the length L1f, the length L1s and the thickness of the gap portion 3g is 0.02 or more and 0.05 or less. The thickness of the gap portion 3g is the length Lge. If the above ratio is 0.02 or more, the fillability of the molded resin portion 4 into the gap portion 3g is high. If the above ratio is 0.05 or less, a predetermined inductance is easily ensured. Moreover, the leakage magnetic flux is small and an effect of reducing an eddy current loss tends to be high. The above ratio may be 0.02 or more and 0.04 or less, or may be 0.02 or more and 0.035 or less.

An example of the length Lge is 1.0 mm or more and 2 mm or less. If the length Lge is 1.0 mm or more, the fillability of the molded resin portion 4 into the gap portion 3g is high. If the length Lge is 2 mm or less, a predetermined inductance is easily ensured. Moreover, the leakage magnetic flux is small and the effect of reducing an eddy current loss tends to be high. The length Lge may be more than 1.0 mm and 2 mm or less, may be 1.2 mm or more and 1.75 mm or less, or may be 1.25 mm or more and 1.5 mm or less.

An example of a length Le along the first direction D1 from the second end surface of the winding portion 21 to the gap portion 3g is 0.2 times or more and 0.49 times or less of the length along the first direction D1 of the winding portion 21. The length Le is a length along the first direction D1 between a position of the gap portion 3g closest to the second end surface and the second end surface. That is, the length Le is a length along the first direction D1 between the end surface 318 shown in FIG. 6 and the second end surface.

If the length Le is 0.2 times or more of the length along the first direction D1 of the winding portion 21, the leakage magnetic flux hardly enters the winding portion 21. Thus, an eddy current loss occurring in the winding portion 21 is easily reduced. The closer to 0.5 times of the length along the first direction D1 of the winding portion 21 the length Le is, i.e. the closer to the center in the first direction D1 of the winding portion 21 the position of the gap portion 3g is, the higher the effect of reducing an eddy current loss tends to be.

If the length Le is 0.49 times or less of the length along the first direction D1 of the winding portion 21, the volume of the first middle core portion 31f tends to be larger than the volume of the second middle core portion 31s inside the winding portion 21. Thus, a ratio of the compact of the composite material having a lower loss than the powder compact easily increases since the volume of the first core portion 3f tends to be larger than the volume of the second core portion 3s. Therefore, the reactor 1 has a low loss. Further, if the length Le is 0.49 times or less of the length along the first direction D1 of the winding portion 21, at least a part of the gap portion 3g is easily constituted by a part of the molded resin portion 4. Since the length Le is 0.49 times or less of the length along the first direction D1 of the winding portion 21, the constituent material of the molded resin portion 4 easily spreads between the end surfaces 312 and 318 even if the total volume Va is 50 cm³ or more. The shorter the length Le, the more easily the constituent material of the molded resin portion 4 spreads between the end surfaces 312 and 318.

The length Le may be 0.2 times or more and 0.4 times or less of the length along the first direction D1 of the winding portion 21 or may be 0.25 times or more and 0.375 times or less of the length along the first direction D1 of the winding portion 21.

### [Intervals Between Coil and First and Second Middle Core Portions]

A ratio of the length Lt to the length Lc (length Lt/length Lc) is 0.05 or more and 0.5 or less, further 0.1 or more and 0.35 or less. The length Lc is an inner dimension of the winding portion 21 along the third direction D3. The length Lt is the sum of lengths Lu and Ld. The length Lu is a length along the third direction D3 between the upper surfaces of the first and second middle core portions 31f, 31s and the inner peripheral surface of the winding portion 21. The length Ld is a length along the third direction D3 between the lower surfaces of the first and second middle core portions 31f, 31s and the inner peripheral surface of the winding portion 21. The upper surfaces are surfaces of the first and second middle core portions 31f, 31s distant from the installation target 100. The lower surfaces are surfaces of the first and second middle core portions 31f, 31s near the installation target 100.

Intervals between the inner peripheral surface of the winding portion 21 and the outer peripheral surfaces of the first and second middle core portions 31f, 31s may be substantially uniform in a circumferential direction. Examples of the intervals between the inner peripheral surface of the winding portion 21 and the outer peripheral surfaces of the first and second middle core portions 31f, 31s are 1.0 mm or more and 5.0 or less, further 1.5 mm or more and 4.0 mm or less. These intervals are minimum intervals.

### [Molded Resin Portion]

The molded resin portion 4 covers at least a part of the magnetic core 3 as shown in FIG. 1 and constitutes at least a part of the gap portion 3g as shown in FIG. 6. The molded resin portion 4 may cover the outer periphery of the magnetic core 3 and may not cover the outer periphery of the coil 2 or may cover both the outer periphery of the magnetic core 3 and the outer periphery of the coil 2. The molded resin portion 4 is not shown in FIG. 5 for the convenience of description.

As shown in FIG. 2, the molded resin portion 4 of this embodiment covers the outer periphery of an assembly of a part of the coil 2 and the magnetic core 3. Thus, this assembly is substantially protected from an external environment. In this embodiment, out of the outer peripheral surface 25, the flat surface near the installation target is exposed from the molded resin portion 4. The outer peripheral surface 25 is covered by the molded resin portion 4 except the flat surface near the installation target. The entire surface of the outer periphery of the magnetic core 3 is covered by the molded resin portion 4. The molded resin portion 4 is provided between the winding portion 21 and the first middle core portion 31f and between the winding portion 21 and the second middle core portion 31s. Further, the molded resin portion 4 is provided at least partially between the end surfaces 312 and 318. In this embodiment, the molded resin portion 4 is provided between the outer end surface 313 and the end surface 318 as shown in FIG. 6. Since heat conduction tends to increase between the first and second core portions 3f, 3s by the molded resin portion 4 including a part provided between the outer end surface 313 and the end surface 318, the reactor 1 is excellent in heat dissipation. The molded resin portion 4 is not substantially provided between the inner end surface 315 and the end surface 318. The coil 2 and the magnetic core 3 are integrated by the molded resin portion 4.

The resin of the molded resin portion 4 is, for example, a resin similar to the resin of the compact of the composite material described above. The resin of the molded resin portion 4 may contain a ceramic filler similarly to the compact of the composite material.

### Miscellaneous

Although not shown, the reactor 1 may be provided with at least one of a case, an adhesive layer and a holding member. The case accommodates the assembly of the coil 2 and the magnetic core 3 inside. The assembly in the case may be embedded by a sealing resin portion. The case is installed on a cooling base or the like. The adhesive layer fixes the assembly to the cooling base or the inner bottom surface of the case or fixes the case to the cooling base or the like. The holding member is provided between the coil 2 and the magnetic core 3 to ensure insulation between the coil 2 and the magnetic core 3.

The reactor 1 has high fillability of the molded resin portion 4 into the gap portion 3g. This is because the constituent material of the molded resin portion 4 filled into the inside of the winding portion 21 easily spreads between the end surfaces 312 and 318 since the area Si/area Se is 1.35 or less and the length Lge/length Lgi is 3.00 or more.

The reactor 1 has a high inductance. This is because the ratio of the inner gap portion 3gi is properly ensured since the area Si/area Se is 0.30 or more. This is also because the length Lge is not excessively large since the length Lge/length Lgi is 15.00 or less.

The reactor 1 is excellent in heat dissipation. This is because heat of the coil 2 can be effectively dissipated via the installation target 100 since the winding portion 21 includes the part to be held in contact with the installation target 100 as shown in FIG. 2. Further, this is because heat conduction tends to increase between the first and second core portions 3f, 3s since the molded resin portion 4 includes the part provided between the outer end surface 313 and the end surface 318 as shown in FIG. 6.

The reactor 1 has a low loss. This is because the ratio of the powder compact having a larger loss than the compact of the composite material is small since the length L1s is shorter than the length L1f. Further, the leakage magnetic flux hardly enters the winding portion 21 since the length Le is 0.2 times or more of the length of the winding portion 21. Thus, an eddy current loss occurring in the winding portion 21 is easily reduced. Further, since the length Le is 0.49 times or less of the length of the winding portion 21, the ratio of the compact of the composite material having a lower loss than the powder compact can be increased inside the winding portion 21.

### Second Embodiment

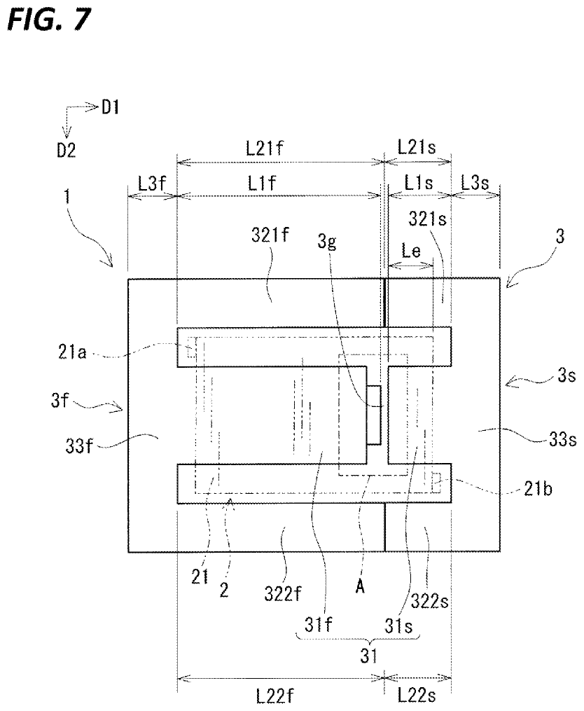

A reactor 1 according to a second embodiment is described with reference to FIG. 7. The reactor 1 of this embodiment differs from the reactor 1 according to the first embodiment in that a combination of a first core portion 31f and a second core portion 3s is an E-E type. That is, the first and second core portions 3f, 3s of this embodiment have an E-shaped planar shape. The following description is centered on points of difference from the first embodiment and the configuration similar to the first embodiment is not described.

### (First Core Portion)

The first core portion 3f of this embodiment includes a first end core portion 33f, a first middle core portion 31f, a first side core portion 321f and a second side core portion 322f. The first core portion 3f of this embodiment differs from that of the first embodiment in that a length L21f of the first side core portion 321f and a length L22f of the second side core portion 322f are shorter than the length L21 of the first side core portion 321 and the length L22 of the second side core portion 322 of the first embodiment.

### (Second Core Portion)

The second core portion 3s of this embodiment includes a second end core portion 33s, a second middle core portion 31s, a first side core portion 321s and a second side core portion 322s. The second core portion 3s is a compact in which the second end core portion 33s, the second middle core portion 31s, the first side core portion 321s and the second side core portion 322s are integrated. The second end core portion 33s connects the second middle core portion 31s and the first and second side core portions 321s, 322s. The first and second side core portions 321s, 322s are provided on both ends of the second end core portion 33s. The second middle core portion 31s is provided in a center of the second end core portion 33s. The first and second side core portions 321s, 322s have a thin angular column shape.

In this embodiment, the first and second core portions 3f, 3s differ in size. A length L21f along the first direction D1 of the first side core portion 321f and a length L22f along the first direction D1 of the second side core portion 322f are equal. The lengths L21f, L22f are longer than a length L1f. A length L21s along the first direction D1 of the first side core portion 321s and a length L22s along the first direction D1 of the second side core portion 322s are equal. The lengths L21s, L22s are longer than a length Lis. The length L1f is longer than the length Lis. The length L21f is longer than the length L21s, and the length L22f is longer than the length L22s. Lengths L3f, L3s are equal.

Lengths along the second direction D2 of the first and second middle core portions 31f, 31s are equal. Lengths along the second direction D2 of the first side core portion 321f, the first side core portion 321s, the second side core portion 322f and the second side core portion 322s are equal. Lengths along the second direction D2 of the first and second end core portions 33f, 33s are equal. Lengths along the third direction D3 of the respective core portions are equal. The lengths along the third direction D3 of the respective core portions are shorter than a length along the third direction D3 of a winding portion 21.

The first and second core portions 3f, 3s are so combined that end surfaces of the first and second side core portions 321f, 322f and end surfaces of the first and second side core portions 321s, 322s are respectively in contact. A gap portion 3g is provided between an end surface of the first middle core portion 31f and an end surface of the second end core portion 33s.

The reactor 1 of this embodiment has high fillability of a molded resin portion 4 into the gap portion 3g similarly to the reactor 1 of the first embodiment. Further, the reactor 1 has a high inductance. Furthermore, the reactor 1 is excellent in heat dissipation and has a low loss.

### Third Embodiment

### [Converter, Power Conversion Device]

The reactors 1 of the first and second embodiments can be utilized for applications satisfying the following energizing conditions. The energizing conditions include, for example, a maximum direct current of about 100 A or more and 1000 A or less, an average voltage of about 100 V or more and 1000 V or less and a use frequency of about 5 kHz or more and 100 kHz or less. The reactor 1 of the first or second embodiment can be typically used as a constituent component of a converter to be installed in a vehicle 1200 such as an electric vehicle, a hybrid vehicle or a fuel cell vehicle or as a constituent component of a power conversion device provided with this converter.

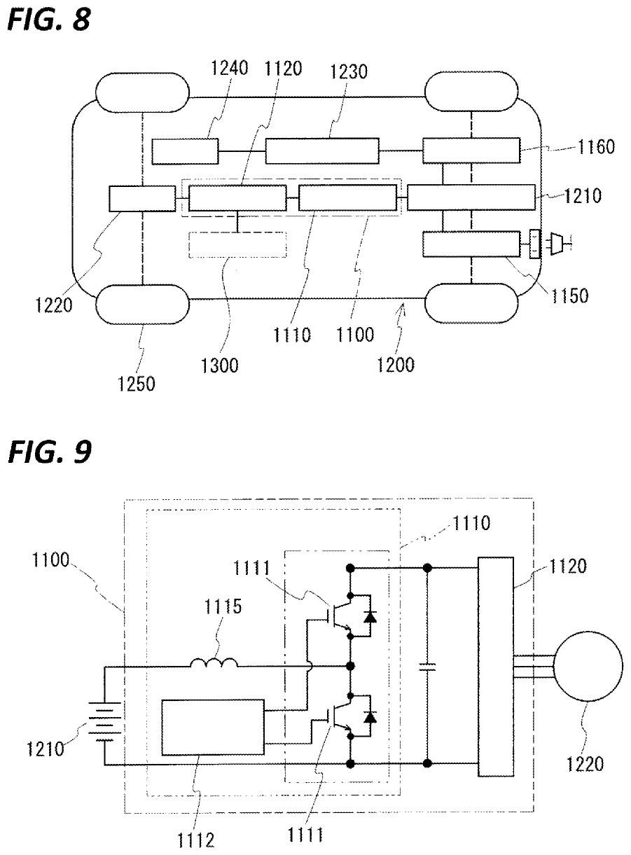

The vehicle 1200 is, as shown in FIG. 8, provided with a main battery 1210, a power conversion device 1100 connected to the main body 1210 and a motor 1220 used for travel by being driven by power supplied from the main body 1210. The motor 1220 is, typically, a three-phase alternating current motor. The motor 1220 drives wheels 1250 during travel and functions as a generator during regeneration. In the case of a hybrid vehicle, the vehicle 1200 includes an engine 1300 in addition to the motor 1220. FIG. 8 shows an inlet as a charging point of the vehicle 1200, but the vehicle 1200 can include a plug.

The power conversion device 1100 includes a converter 1110 to be connected to the main battery 1210 and an inverter 1120 connected to the converter 1110 for the mutual conversion of a direct current and an alternating current. The converter 1110 shown in this example steps up an input voltage of the main battery 1210 of about 200 V or more and 300 V or less to about 400 V or more and 700 V or less and supplies the stepped-up voltage to the inverter 1120 during the travel of the vehicle 1200. The converter 1110 steps down an input voltage output from the motor 1220 via the inverter 1120 to a direct-current voltage suitable for the main battery 1210 and charges the main battery 1210 with the direct-current voltage during regeneration. The input voltage is a direct-current voltage. The inverter 1120 converts the direct current stepped up by the converter 1110 into a predetermined alternating current and supplies the converted current to the motor 1220 during the travel of the vehicle 1200 and converts an alternating current from the motor 1220 into a direct current and outputs the direct current to the converter 1110 during regeneration.

The converter 1110 includes a plurality of switching elements 1111, a drive circuit 1112 for controlling the operation of the switching elements 1111 and a reactor 1115 as shown in FIG. 9 and converts an input voltage by being repeatedly turned on and off. The conversion of the input voltage means voltage step-up and -down here. A power device such as a field effect transistor or an insulated gate bipolar transistor is used as the switching element 1111. The reactor 1115 has a function of smoothing a change of a current when the current is increased or decreased by a switching operation, using a property of a coil to hinder a change of a current flowing into a circuit. The reactor 1 of the first embodiment is provided as the reactor 1115. By including the reactor 1, the power conversion device 1100 and the converter 1110 are excellent in performance.

Besides the converter 1110, the vehicle 1200 is provided with a power supply device converter 1150 connected to the main battery 1210 and an auxiliary power supply converter 1160 connected to a sub-battery 1230 and the main battery 1210 serving as power sources of auxiliary devices 1240 and configured to convert a high voltage of the main battery 1210 into a low voltage. The converter 1110 typically performs DC-DC conversion, but the power supply device converter 1150 and the auxiliary power supply converter 1160 perform AC-DC conversion. The power supply device converter 1150 may perform DC-DC conversion. Reactors configured similarly to the reactor 1 of the first embodiment and appropriately changed in size, shape and the like can be used as reactors of the power supply device converter 1150 and the auxiliary power supply converter 1160. Further, the reactor 1 of the first embodiment and the like can also be used as converters for converting input power and only stepping up a voltage or only stepping down a voltage.

### Test Example

Differences in the inductance and loss of the reactor due to differences in the area Si/area Se described above or differences in the length Lge/length Lgi described above were examined. In this test example, actually manufactured reactors were not evaluated, but reactors were constructed on a simulation software and analysis models having the area Si/area Se and the length Lge/length Lgi set therefor were evaluated.

### [Sample No. 1 to Sample No. 16]

The assembly of the coil 2 and the magnetic core 3 as shown in FIG. 1 was constructed as each of analysis models of Samples No. 1 to No. 16. That is, the analysis model of each sample was not provided with the molded resin portion 4 as shown in FIG. 1.

The end surface of the first middle core portion 31f in each sample was an end surface similar to the end surface 312 including the outer end surface 313, the peripheral surface 314 and the inner end surface 315 described with reference to FIG. 3. The shape of the inner end surface in each sample had a true circular shape or a square shape as shown in Table 1 or Table 2. Four corner parts of the inner end surface and four corner parts of the outer end surface in Samples No. 2 to No. 16 were rounded. The area Si, the area Se and the area Si/area Se in each sample are shown in Table 1 or Table 2. The area Si is an area of the inner end surface, and the area Se is an area of the outer end surface. The area Si/area Se was adjusted by adjusting the area Si. The area Si/area Se in each table is rounded off to the third decimal.

The end surface of the second middle core portion 31s in each sample was a flat surface. The length Lge, the length Lgi and the length Lge/lg Lgi in each sample are shown in Table 1 or Table 2. The length Lge is a thickness of the outer gap portion, and the length Lgi is a thickness of the inner gap portion. The length Lge/lg Lgi was adjusted by adjusting the length of the peripheral surface. The length Lge/lg Lgi in each table is rounded off to the third decimal.

The length Le in each sample satisfied to be 0.2 times or more and 0.49 or less of the length in the first direction D1 of the winding portion 21. A ratio of the length Lge to a total length of the lengths L1f, L1s and Lge in each sample satisfied to be 0.02 or more and 0.05 or less. In each sample, a ratio (Lt/Lc) of the length Lt to the length Lc was about 0.14. In each sample, intervals between the inner peripheral surface of the winding portion 21 and the outer peripheral surfaces of the first and second middle core portions 31f, 31s were about 2.5 mm.

### [Sample No. 100]

Sample No. 100 was similar to Sample No. 1, etc. except that the end surface of the first middle core portion 31f was a flat surface and a thickness of the gap portion was 1.0 mm.

### [Analysis]

One of two members obtained cutting each sample by a flat surface passing through a center of the coil 2 and parallel to the first and third directions D1, D3 was used for analysis. An electromagnetic field analysis software JMAG-Designer Ver. 20.1 produced by JSOL Corporation was used as an analysis software. An analysis method is a magnetic field transient response analysis (solution method: A−ϕ method 2).

### [Inductance]

A current of 1 A to 400 A was applied to the coil, and an inductance was calculated from an interlinkage magnetic flux amount of the coil at each current value obtained by analysis. Maximum values of the calculated inductances are shown in Table 1 or Table 2. The inductances shown in each Table are ratios (%) when a maximum value of the inductance of Sample No. 100 is 100.

### [Loss]

A voltage of a specific frequency was applied to the coil, and a Joule loss of the coil and an iron loss of the magnetic core were calculated based on a magnetic flux density distribution and a current density distribution. The calculated losses of the coils and the overall losses are shown in Table 1 or Table 2. The overall loss was obtained based on the loss of the coil and the loss of the magnetic core. Each of the losses of the coils and the overall losses shown in each Table is a ratio (%) when each of the loss of the coil and the overall loss of Sample No. 100 is 100.

TABLE 1

| | | | | | | | Length | | Loss | |
|---|---|---|---|---|---|---|---|---|---|---|
| | Shape of | | | | Length | Length | Lge/ | Max Value of | Loss of | Overall |
| Sample | Inner End | Area Si | Area Se | Area Si/ | Lge | Lgi | Length | Inductance | Coil | Loss |
| No. | Surface | mm² | mm² | Area Se | mm | mm | Lgi | % | % | % |
| 1 | True | 46 | 830 | 0.06 | 1.5 | 0.5 | 3.00 | 95.5 | 106.5 | 102.4 |
| | Circular | | | | | | | | | |
| 2 | Square | 90 | 786 | 0.11 | 1.5 | 0.5 | 3.00 | 96.6 | 104.8 | 102.0 |
| 3 | Square | 146 | 730 | 0.20 | 1.5 | 0.5 | 3.00 | 97.9 | 103.0 | 101.6 |
| 4 | Square | 214 | 661 | 0.32 | 1.5 | 0.5 | 3.00 | 99.2 | 101.4 | 101.2 |
| 5 | Square | 296 | 580 | 0.51 | 1.5 | 0.5 | 3.00 | 100.7 | 100.0 | 100.8 |
| 6 | Square | 389 | 486 | 0.80 | 1.5 | 0.5 | 3.00 | 102.1 | 98.8 | 100.4 |
| 7 | Square | 496 | 380 | 1.31 | 1.5 | 0.5 | 3.00 | 103.6 | 98.0 | 100.1 |
| 8 | Square | 614 | 361 | 1.70 | 1.5 | 0.5 | 3.00 | 105.0 | 97.4 | 99.9 |
| 100 | | | | | | | | 100 | 100 | 100 |

TABLE 2

| | | | | | | | Length | | Loss | |
|---|---|---|---|---|---|---|---|---|---|---|
| | Shape of | | | | Length | Length | Lge/ | Max Value of | Loss of | Overall |
| Sample | Inner End | Area Si | Area Se | Area Si/ | Lge | Lgi | Length | Inductance | Coil | Loss |
| No. | Surface | mm² | mm² | Area Se | mm | mm | Lg | % | % | % |
| 9 | Square | 214 | 661 | 0.32 | 1.5 | 0.1 | 15.00 | 104.6 | 98.3 | 102.3 |
| 10 | Square | 214 | 661 | 0.32 | 1.5 | 0.25 | 6.00 | 102.1 | 99.2 | 101.4 |
| 11 | Square | 214 | 661 | 0.32 | 1.5 | 0.4 | 3.75 | 100.2 | 100.5 | 101.1 |
| 12 | Square | 214 | 661 | 0.32 | 1.5 | 0.6 | 2.50 | 98.4 | 102.3 | 101.3 |
| 13 | Square | 214 | 661 | 0.32 | 1.5 | 0.75 | 2.00 | 97.3 | 103.7 | 101.5 |
| 14 | Square | 214 | 661 | 0.32 | 1.5 | 0.9 | 1.67 | 96.4 | 104.9 | 101.8 |
| 15 | Square | 214 | 661 | 0.32 | 1.5 | 1.05 | 1.43 | 95.7 | 106.0 | 102.1 |
| 16 | Square | 214 | 661 | 0.32 | 1.5 | 1.2 | 1.25 | 95.1 | 107.1 | 102.5 |
| 100 | | | | | | | | 100 | 100 | 100 |

As shown in Table 1, the maximum values of the inductances of Samples No. 4 to No. 7 were equal to or more than the maximum value of the inductance of Sample No. 100 and larger than the maximum values of the inductances of Samples No. 1 to No. 3. Further, the losses of the coils of Samples No. 4 to No. 7 were equal to or less than the loss of the coil of Sample No. 100 and smaller than the losses of the coils of Samples No. 1 to No. 3. The overall losses of Samples No. 4 to No. 7 were nearly equal to the overall loss of Sample No. 100 and smaller than the overall losses of Samples No. 1 to No. 3.

As shown in Table 2, the maximum values of the inductances of Samples No. 9 to No. 11 were equal to or more than the maximum value of the inductance of Sample No. 100 and larger than the maximum values of inductances of Samples No. 12 to No. 16. Further, the losses of the coils of Samples No. 9 to No. 11 were equal to or less than the loss of the coil of Sample No. 100 and smaller than the losses of the coils of Samples No. 12 to No. 16. The overall losses of Samples No. 9 to No. 11 were nearly equal to the overall losses of Samples No. 12 to No. 16 and Sample No. 100.

The fillability of the molded resin portion into the gap portion was examined using a resin fluidity analysis software Moldex 3D studio 2020 produced by JSOL Corporation. The molded resin portion was made of polyphenylene sulfide resin containing glass fibers. The constituent material of the molded resin portion was filled into the inside of the winding portion 21 from the outside of the assembly. The fillability of the resin into between the end surface of the first middle core portion 31f and the end surface of the second middle core portion 31s was visually confirmed with reference to a contour diagram. As a result, it was found that the larger the area Se, the larger the filled amount of the molded resin portion into the outer gap portion. Particularly, Samples No. 1 to No. 7 and No. 9 to No. 16 had a larger filled amount of the molded resin portion into the outer gap portion than Sample No. 8. Further, in Samples No. 1 to No. 16, the molded resin portion was not substantially filled in the inner gap portion. In Sample No. 100, the molded resin portion was not substantially filled in the gap portion.

From the above results, it was found that Samples No. 4 to No. 7 and No. 9 to No. 11 had high fillability of the molded resin portion into the gap portion and had a high inductance.

The present invention is not limited to these illustrations, but is represented by claims and intended to include all changes in the scope of claims and in the meaning and scope of equivalents.

### LIST OF REFERENCE NUMERALS

1 reactor
2 coil
21 winding portion, 21a first end part, 21b second end part
25 outer peripheral surface
3 magnetic core, 3f first core portion, 3s second core portion
31f first middle core portion
311 outer peripheral surface
312 end surface
313 outer end surface, 314 peripheral surface, 315 inner end surface
31s second middle core portion
318 end surface
321, 321f, 321s first side core portion
322, 322f, 322s second side core portion
33f first end core portion, 33s second end core portion
3g gap portion
3ge outer gap portion, 3gi inner gap portion
4 molded resin portion
L1f, L1s length
L21, L21f, L21s length
L22, L22f, L22s length
L3f, L3s length
Le length
D1 first direction, D2 second direction, D3 third direction
A region
100 installation target
1100 power conversion device, 1110 converter
1111 switching element, 1112 drive circuit, 1115 reactor
1120 inverter
1150 power supply device converter, 1160 auxiliary power supply converter
1200 vehicle
1210 main battery, 1220 motor, 1230 sub-battery
1240 auxiliary devices, 1250 wheel
1300 engine

1. A reactor, comprising:
a coil including a tubular winding portion;
a magnetic core including a first core portion and a second core portion combined in an axial direction of the winding portion and a gap portion provided between the first and second core portions; and
a molded resin portion covering at least a part of the magnetic core,
one winding portion being provided,
the first core portion being E-shaped,
the second core portion being T-shaped or E-shaped,
the first core portion being a compact of a composite material including a first middle core portion arranged inside the winding portion,
the second core portion being a powder compact including a second middle core portion arranged inside the winding portion,
the gap portion being arranged between an end surface of the first middle core portion and an end surface of the second middle core portion inside the winding portion,
the end surface of the first middle core portion having:
an annular outer end surface connected to an outer peripheral surface of the first middle core portion;
a peripheral surface extending from the outer end surface toward the end surface of the second middle core portion; and
an inner end surface connected to a tip of the peripheral surface,
the end surface of the second middle core portion being a flat surface,
the outer end surface and the inner end surface being flat surfaces,
a ratio of an area of the inner end surface to an area of the outer end surface being 0.30 or more and 1.35 or less, and
the molded resin portion including a part to be provided between the outer end surface and the end surface of the second middle core portion.

2. The reactor of claim 1, wherein a ratio of a length between the outer end surface and the end surface of the second middle core portion to a length between the inner end surface and the end surface of the second middle core portion is 3.00 or more and 15.00 or less.

3. The reactor of claim 1, wherein:
a length of the second middle core portion along the axial direction of the winding portion is shorter than a length of the first middle core portion along the axial direction of the winding portion, and
a length from an end surface of the winding portion facing the second core portion to the gap portion is 0.2 times or more and 0.49 times or less of a length of the winding portion.

4. The reactor of claim 1, wherein a ratio of a thickness of the gap portion to a total length of a length of the first middle core portion along the axial direction of the winding portion, a length of the second middle core portion along the axial direction of the winding portion and the thickness of the gap portion is 0.02 or more and 0.05 or less.

5. The reactor of claim 1, wherein a thickness of the gap portion is 1.0 mm or more and 2 mm or less.

6. The reactor of claim 1, wherein:
the powder compact is a compact of a raw material powder containing a soft magnetic powder, and
a content of the soft magnetic powder in the powder compact is 85% by volume or more and 99% by volume or less.

7. The reactor of claim 1, wherein:
the compact of the composite material is a compact in which a soft magnetic powder is dispersed in a resin, and
a content of the soft magnetic powder in the compact of the composite material is 20% by volume or more and 80% by volume or less.

8. A converter, comprising the reactor of claim 1.

9. A power conversion device, comprising the converter of claim 8.
